(19) United States
(12) Patent Application Publication
(10) Pub. No.: US 2008/0065524 A1
(43) Pub. Date: Mar. 13, 2008

(54) System for integrating post-trade processing applications

(76) Inventors: Steven Matthews, Cohasset, MA (US); Christopher J. Walsh, Kingston, MA (US)

Correspondence Address: ST. ONGE STEWARD JOHNSTON & REENS, LLC, 986 BEDFORD STREET, STAMFORD, CT, 06905-5619, US

(21) Appl. No.: 11/520,264

(22) Filed: Sep. 13, 2006

(51) Int. Cl. G06Q 40/00

(52) U.S. Cl. 705/37

(57) ABSTRACT

A system for facilitating post-trade processing of a securities trade including an integration server, a plurality of post-trade systems accessible by the integration server, software executing on the integration server for receiving trade allocation data from at least one investment manager via a user interface, software executing on the integration server for receiving trade execution data from at least one broker, software executing on the integration server for determining, at least in part based on content of the data, at least one of the post-trade systems corresponding to at least one of the trade execution data and the trade allocation data, software executing on the integration server for sending at least a portion of the trade execution data and the trade allocation data to the at least one determined post-trade system, and software executing on the integration server for receiving confirmation data from the at least one determined post-trade system.

### FIELD OF THE INVENTION

The present invention relates to a system for facilitating the processing and settlement of securities trades, and more particularly, to a system which integrates multiple post-trade processing applications into a single interface.

### BACKGROUND OF THE INVENTION

A variety of systems have been developed for automating portions of the securities trading industry. For example, British patent publications GB 2 161 003 A and GB 2 210 714 A are directed to systems for distributing, processing and displaying financial information. Similarly, U.S. Pat. No. 4,949,248 discloses a local area network for shared access of information services or shared control of applications, aimed particularly at trading rooms of securities firms. Other systems include U.S. Pat. Nos. 4,346,442, 4,376,978 and 4,774,663 which are directed to systems for operating and maintaining securities brokerage-cash management accounts, and U.S. Pat. Nos. 4,674,044, 4,823,265 and 5,101,353 which disclose electronic trade execution systems.

None of the above prior art systems, however, are directed to improving the speed and accuracy of communication of the instructions for exchanging the purchase money and the security to settle an executed trade. Thus, none of the prior art systems adequately speeds trade settlement which is accomplished, if at all, by a patchwork of faxes, telexes, and telephone calls among the trading parties.

Systems for automating the settlement of securities trades and the delivery of trade confirmations have been developed to remedy many of the deficiencies of the prior art systems discussed above. These systems, commonly known as Electronic Trade Confirmation (“ETC”) systems, reduce the number of tasks required to confirm a trade, and automate most of the remaining tasks, which tasks would have to be performed manually if such an ETC system were not used. Thus, the ETC systems currently in use reduce the time and effort required to settle a securities trade, as compared to the traditional laborious manual method of sequentially exchanging messages by telephone or telex. However, these prior art ETC systems still suffer from certain deficiencies of their own.

U.S. Pat. No. 5,497,317 discloses a system which is based on a series of messages flowing back and forth between institutions, brokers and custodians. This prior art system thus automates many of the tasks which had previously required human intervention, and therefore reduces the time required to settle trades, typically to within three days of the trade date, so-called “T+3”. However, “T+3” has been viewed in the securities trading industry as a transitionary phase, not as an end goal. It is anticipated that the Securities and Exchange Commission may someday require settlement to occur within one day of the trade date (“T+1”) and possibly even on the same day as the trade date (“T+0”).

Furthermore, despite some developments in the securities industry including software to assist in various stages of the post-trade settlement process, investment managers and investment manager outsourcers continue to be challenged by inefficiencies with their post-trade process. Presently, the post trade process involves the use of multiple interfaces and multiple infrastructures. Such complex environments foster the potential for multiple failure points and are difficult and costly to maintain. For example, a prior art post-trade processing system is shown in FIG. 1. The numerous post-trade applications and utilities each require a separate interface and infrastructure. As such, post-trade processing with prior art systems is still time consuming and error prone.

What is desired, therefore, is a system for facilitating the processing and settlement of securities trades which provides a single connection to an open post-trade environment integrating multiple post-trade solutions.

### SUMMARY OF THE INVENTION

Accordingly, it is an object of the present invention to provide a system which provides a single point of access for investment managers and investment outsourcers to interact with multiple post-trade systems, products, applications and utilities.

It is also an object to provide a system which provides a single point of access to multiple market infrastructures, data providers, and trade counterparties involved in the post-trade process.

It is also an object to provide a system which enables the trade and settlement management of multiple asset classes and markets via an application service provider (“ASP”) environment.

These and other objectives are achieved in accordance with an embodiment of the present invention by providing a system for facilitating post-trade processing of a securities trade including an integration server, a plurality of post-trade systems accessible by the integration server, software executing on the integration server for receiving trade allocation data from at least one investment manager via a user interface, software executing on the integration server for receiving trade execution data from at least one broker, software executing on the integration server for determining, at least in part based on content of the data, at least one of the post-trade systems corresponding to at least one of the trade execution data and the trade allocation data, software executing on the integration server for sending at least a portion of the trade execution data and the trade allocation data to the at least one determined post-trade system, and software executing on the integration server for receiving confirmation data from the at least one determined post-trade system.

Further provided is a system for facilitating post-trade processing of a securities trade, including an integration server, a plurality of trade matching applications accessible by the integration server for matching trades in at least three asset classes, software executing on the integration server for receiving trade allocation data from at least one first trading party via a user interface, software executing on the integration server for receiving trade execution data from at least one second trading party, software executing on the integration server for determining, based at least in part on content of the data, at least one of the plurality of trade matching applications corresponding to each of the trade execution data and the trade allocation data, an application accessible by the integration server for receiving trade settlement instructions corresponding to at least one of the trade allocation data and the trade execution data, and software executing on the integration server for providing status data from the plurality of trade matching applications to the at least one first trading party via the user interface.

Further provided is a method for facilitating post-trade processing, including the steps of receiving a plurality of trade allocation data from at least one first trading party, receiving a plurality of trade execution data from at least one second trading party, determining an asset class for each of the trade execution data and the trade allocation data, determining a post-trade matching system for each of the trade execution data and the trade allocation data, comparing trade execution data pertaining to a particular asset class with trade allocation data pertaining to the particular asset class to determine a match, and generating confirmation data for transmission to the at least first trading party and the at least one second trading party if a match is found.

Other objects, features and advantages according to the present invention will become apparent from the following detailed description of certain advantageous embodiments when read in conjunction with the accompanying drawings in which the same components are identified by the same reference numerals.

### BRIEF DESCRIPTION OF THE DRAWINGS

FIG. 1 is a schematic diagram of a prior art system for post-trade processing.

FIG. 2 is a schematic diagram of a system for facilitating post-trade processing of a securities trade according to an exemplary embodiment of the present invention.

FIG. 3 is another schematic diagram of the system for facilitating post-trade processing of a securities trade of FIG. 2.

FIG. 4 is a screenshot of an exemplary user interface generated by the system is shown in FIGS. 2 and 3.

FIG. 5 illustrates an exemplary method for facilitating post-trade processing of a securities trade employable by the system shown in FIGS. 2 and 3.

### DETAILED DESCRIPTION OF THE INVENTION

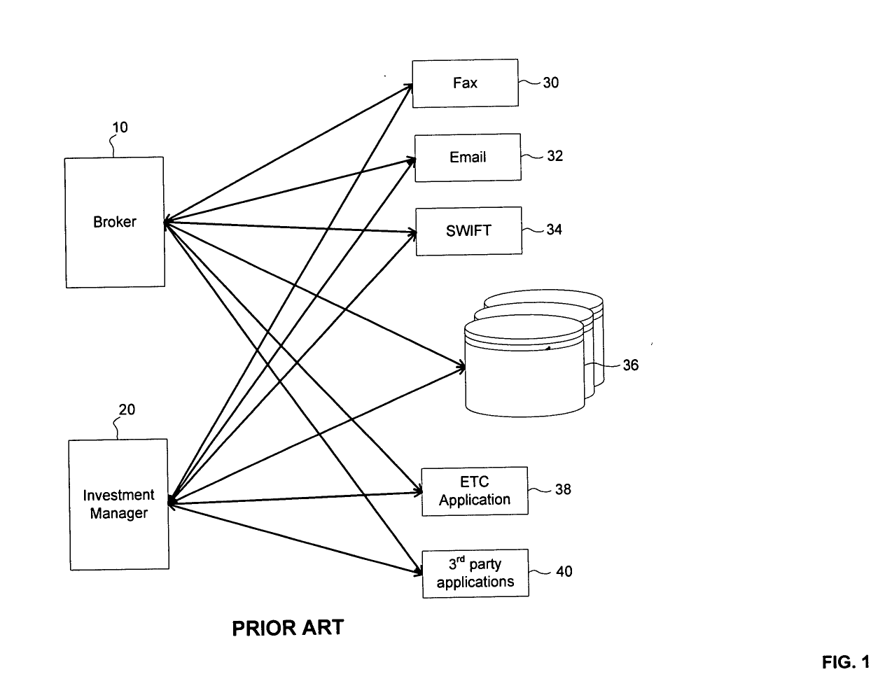

FIG. 1 shows a prior art system for post-trade processing. The prior art system includes a broker 10 and investment manager 20. The system includes numerous post-trade applications and utilities including a fax device or application 30, an email application 32 and a SWIFT (“Society for Worldwide Interbank Financial Telecommunication”) message application 34. The prior art system further includes access to several databases 36 including data pertaining to the trade and settlement procedures. Other tools or applications may also be present, such as an electronic trade confirmation system or application 38 and other third party post-trade processing applications 40. While some post-trade applications and utilities are available, each requires a separate interface and infrastructure and a separate step in the post-trade process. As such, there are multiple potential failure points in the current post-trade environment. Furthermore, often such applications are unique to particular asset classes and therefore even more separate interfaces and infrastructures are required.

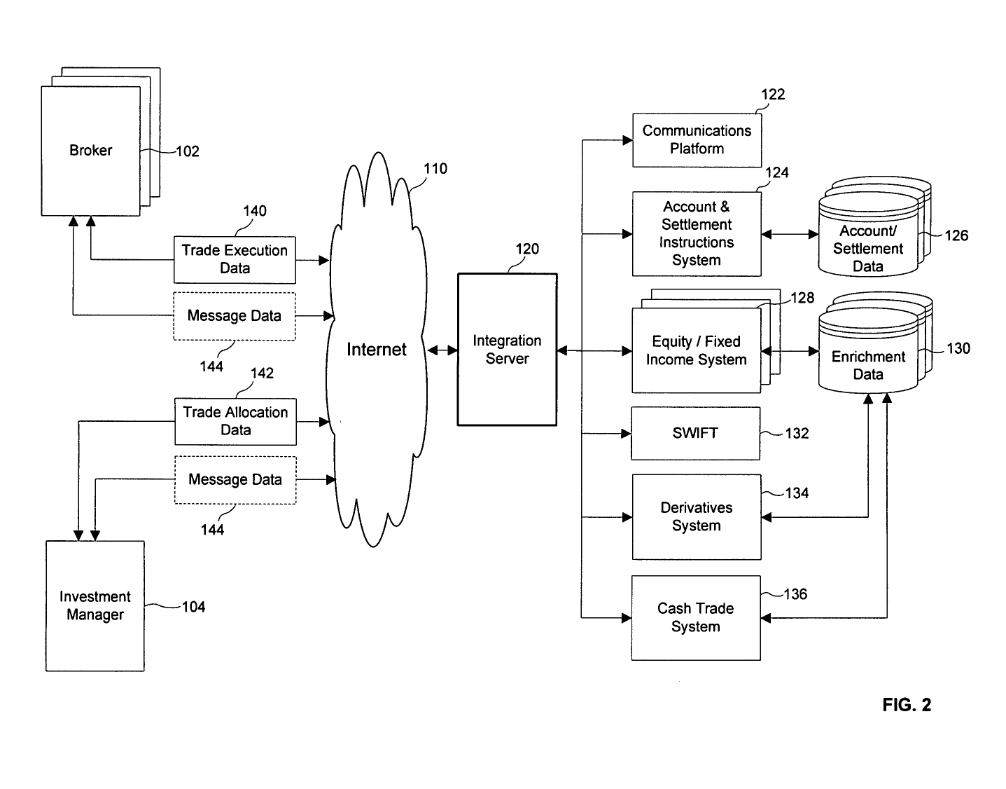

FIG. 2 shows a diagram of a system for facilitating post-trade processing of a securities trade according to an exemplary embodiment of the present invention. The system is accessible by and receives information from any number of brokers 102. The brokers 102 may be brokers of any asset class, including but not limited to, stocks or equities, bonds or fixed-income investments, money markets and derivatives. The brokers 102 may further execute trades in any markets or exchanges, e.g., in the United States or abroad. The system is further accessible by at least one investment manager 104 (“IM”) or investment manager outsourcer (“IMO”).

The system according to the present invention further includes an integration server 120 accessible by the investment managers 104 and brokers 102 via the Internet 110 or other communications link. The integration server 120 interacts with and integrates the functionality of a plurality of post-trade processing systems, applications and utilities. The post-trade processing systems may be in any location and accessible to the integration server 120 by a communications link or communications network. For example, some of the post-trade processing systems or applications may reside on the integration server or a server local thereto. Some other post-trade systems or applications may be located in any remote location and accessible via the Internet or other communications link.

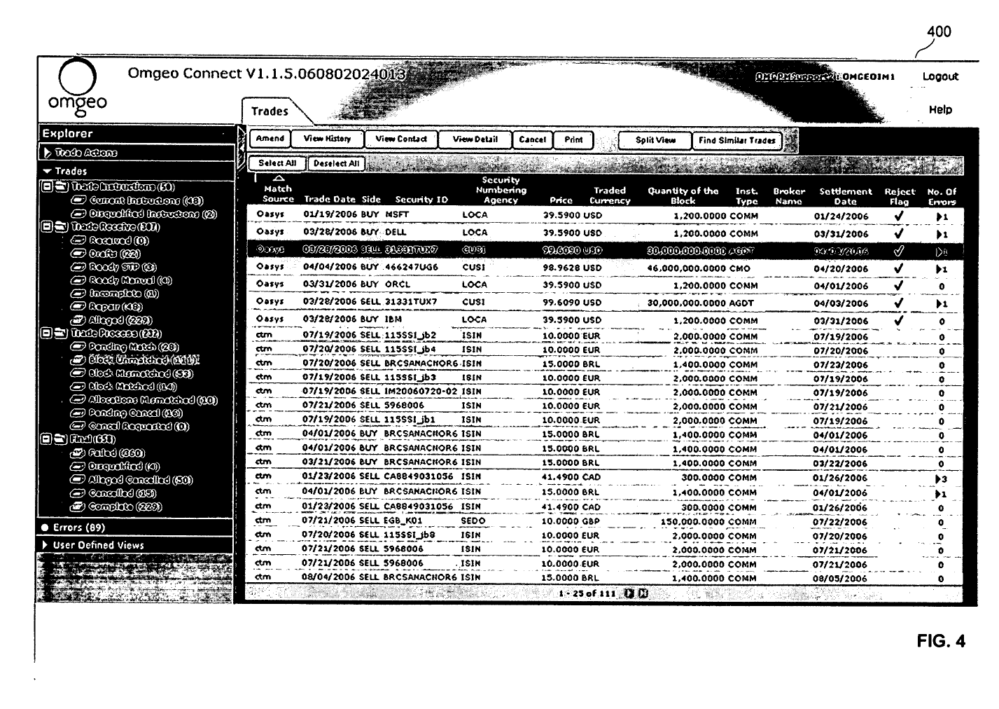

The server 120 further includes software executing thereon for providing a network-based (e.g., Internet-based) user interface to the investment managers 104 and/or brokers 102 for single source access to the plurality of post-trade applications, applications and utilities. The user interface provides real-time consolidated data and information, such as trade match statuses and confirmations, from any number of the post-trade applications (see, e.g., FIG. 4).

Among the post-trade applications integrated by the integration server is included one or more communications platforms or systems 122. The communications platform 122 provides the capabilities to send and receive messages (e.g., message data 144) via fax, email, HTTPS, FTP, XML, SWIFT and/or SWIFTNET through the user interface of the integration server 120. The communications platform 122 sends and receives message data between the investment manager 104 and any number of trade counterparties (e.g., brokers), institutions (e.g., financial institutions), and data providers. The communications platform 122 may send and receive message data 144 in any format and translate the message data 144 between formats as necessary. The communications platform 122 may also provide the investment manager 104 with real-time status information of a message. In one embodiment, one of the communications systems or platforms 122 is BBH Infomediary® provided by Brown Brothers Harriman. As shown in FIG. 2, the system may further include a SWIFT message data system 132 integrated by the integration server 120 for providing access to a secure SWIFT network.

Further included is at least one account details and settlement instructions application or system 124 for providing account details and settlement instructions to the investment managers 104 and trade counterparties. The application 124 includes, or is in communication with, any number of databases (e.g., web-based databases) for the maintenance and communication of standing settlement and account instructions (“SSI”), such as account and settlement databases 126. The databases may include account and settlement details and/or instructions for any number of investment managers, brokers, and financial institutions. In one embodiment the application 124 is Omgeo ALERT^{SM} provided by Omgeo LLC.

The system according to the present invention further includes one or more equity and fixed income trade matching applications or systems 128. The equity and fixed income trade matching applications 128 provide for real-time central matching of trade execution data and trade allocation data for the equity and fixed income asset classes. Some of the applications 128 may provide matching for one or more particular markets or exchanges, in the U.S. or worldwide. The equity and fixed income trade matching applications 128 may include, for example, Omgeo OASYS^{SM}, Omgeo OASYS Global^{SM}, Omgeo OASYS Tradematch and/or Omgeo Central Trade Manager® (“CTM”). The equity and fixed income trade matching applications 128 may further include any number of other such systems and applications regardless of the manufacturer or provider. Each of the applications 128 may also receive enrichment data from any number of enrichment databases 130 to assist in the matching and confirmation of trade execution and allocation data.

Further included is a derivative trade matching application or system 134 accessible by the investment managers 104 via the integration server 120. The derivative trade application 134 provides for the matching and confirming of over the counter (“OTC”) derivative trades. The derivative trade application 136 may provide for entity credit default swaps (“CDS”), CDS indices, interest rate swaps, swaptions, variance swaps, equity swaps, equity index options and equity share options. The application 134 may further provide on-line research and management reporting capabilities. In one embodiment, the derivative trade matching application 134 includes the DTCC Deriv/SERV system offered by the Depository Trust & Clearing Corporation. The integration server 120 may also be in communication with any number of cash or money market transaction applications 136 for matching and confirmation cash or money market trades. The applications 132 and 136 may receive enrichment data from any number of enrichment databases (e.g., 130) as necessary.

The integration server 120 of the present invention further includes software for receiving data or information from the investment managers 104 and/or brokers, such as trade execution data 140, trade allocation data 142 and/or message data 144. The trade allocation data 142 includes data indicative of an ordered trade, such as an ID number, type of order (e.g., buy/sell), a share/face value, a settlement amount, and/or a date (e.g., trade date or settlement data). The trade execution data 140 may include similar data types indicative of an executed trade. The integration server 120 provides for the receipt of isolated data from trade parties and batch data. The data may be received from any number of brokers and investment managers in any asset class, market and/or exchange, e.g., via the user interface of the integration server 120. Further, trade data 140/142 may also be sent and received directly with particular post-trade applications (e.g., by brokers and/or investment managers without access to system and integration server 120 of the present invention).

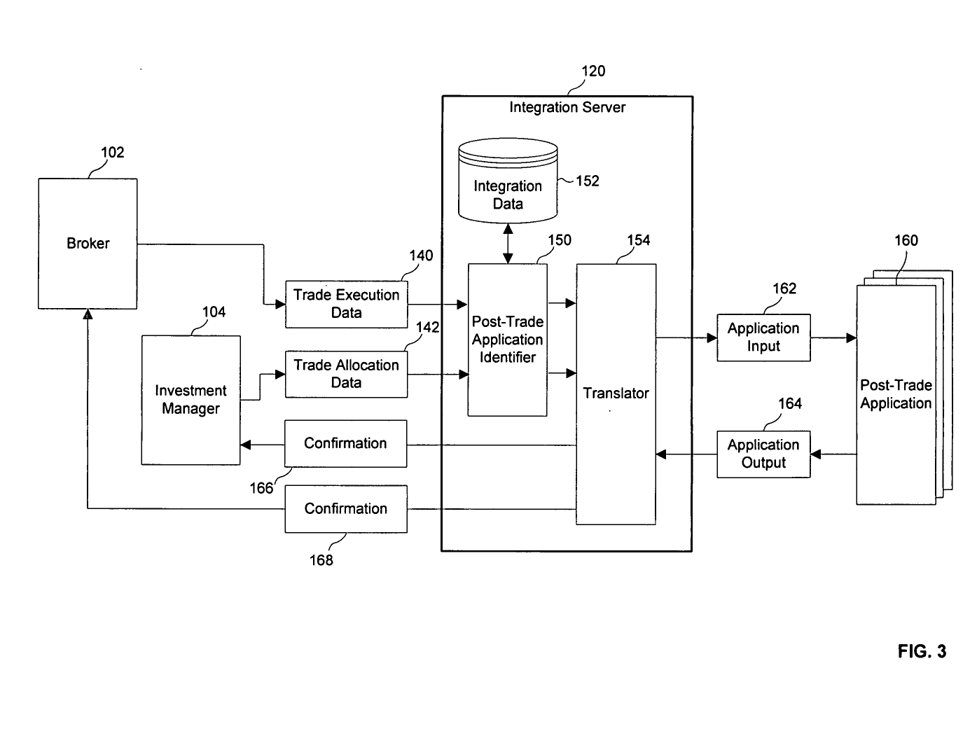

FIG. 3 shows another diagram of a system according to the present invention. The integration server 120 includes a post-trade application identifier 150 for determining a post-trade application or system 160 corresponding to received trade execution data 140 and/or trade allocation data 142. For example, the identifier 150 may determine, based on the content of the data, one or more post-trade applications for processing the trade execution data 140 and/or trade allocation data 142. The post-trade application identifier 150 may be embodied in software, hardware, or a combination of both. The identifier 150 determines such application or applications based on any number of properties of the data 140/142 or the broker or investment manager providing the data 140/142. For example, the post-trade application identifier 150 may determine one or more post-trade systems 160 for processing the data based on asset class associated with received data 140 and/or data 142. Alternatively, a broker 102 or investment manager 104 may manually select one or more appropriate post-trade systems or applications 160, such as matching application or system.

In some embodiments, the integration server 120 includes one or more tables or databases (e.g., integration database 152) including data content or identifiers which identify or indicate particular post-trade applications or systems integrated by the integration server 120. Software for determining the appropriate post-trade system to process trade execution and/or trade allocation data 140/142 may therefore query the table and compare content of the data 140/142 thereto.

Many of the post-trade systems and applications integrated by the system of the present invention further include security measures, such as secure user ID's and passwords. Therefore, the integration database 152 may further include security data necessary to access each of the post-trade systems or applications. The database 152 may be local to the integration server 120 or remote and accessible via the Internet. In some embodiments, security data is stored local to each corresponding investment manager and/or broker. The security data may include, e.g., user ID and password information for each of the post-trade applications, systems and utilities. The system according to the present invention therefore provides for the automatic log-in and authentication of an investment manager or broker in post-trade applications.

Trade execution data 140 and trade allocation data 142 received from brokers and investment managers, respectively, can be translated into a data format corresponding to at least one identified post-trade application by a translator 154 of the integration server 120. The translator 154 may be embodied in software, hardware, or a combination of both. In some embodiments, particular post-trade applications include translators and may therefore receive non-translated data in any format. A plurality of application inputs 162 may be provided to one or more identified post-trade applications 160. The application input 162 may include at least a portion of trade execution data 140 and/or trade allocation data 142 received from a plurality of brokers 102 and investment managers 104. Application input 162 may further include message data 144.

The post-trade applications 160 may provide any number of application outputs 164 to the investment manager 104 and/or broker 102. For example, some post-trade applications 160, such as equity or fixed income application or system 128, attempt to match received trade execution data to trade allocation data. If a particular post-trade application finds a match, a confirmation 166/168 is sent to the corresponding broker 102 and investment manager 104. Alternatively, an error or exception notice may be sent if a match is not determined. The confirmation 166/168 (e.g., or exception) may be sent by any means. For example, the confirmation 166/168 may be displayed via the web-based user interface of the present invention. The system further provides other application output 164, confirmations and notifications via the web-based user interface including notification of pending matches, errors, cancelled trades, etc. Application output 164 may further include account and settlement data and/or enrichment data from any number of databases accessible by the system. Confirmations and notifications are displayed together in the same user interface regardless of the matching application, asset class, market or exchange. An exemplary embodiment of a user interface 400 of the system is shown in FIG. 4.

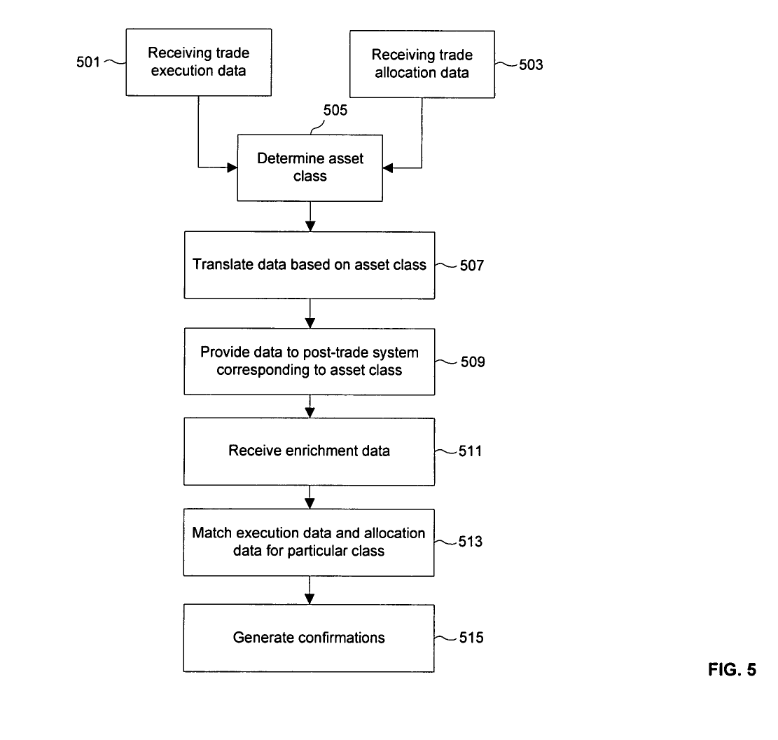

FIG. 5 illustrates an exemplary method for facilitating post-trade processing of a securities trade employable by the system shown in FIGS. 2 and 3. The method includes steps of receiving trade allocation data and trade execution data, e.g., from investment managers 104 and/or brokers 102 (Steps 501/503). Isolated trade allocation and execution data may be received, or a plurality of data may be received in a batch. Trade allocation and execution data may be received at any time and may pertain to any number of asset classes and/or markets. Therefore, the particular asset class (e.g., and market) is determined for each of the trade allocation and trade execution data (step 505). The post-trade applications and systems necessary to settle each trade is determined and the data format translated as necessary (step 507). Trade allocation and trade execution data is then provided to the corresponding post-trade applications (step 509). Enrichment data, such as account information and/or settlement instructions, is received for the trade allocation and trade execution data (step 511). Next, trade execution data and allocation data are matched (step 513). If matches are determined, confirmation data is generated and transmitted to the appropriate investment manager and brokers (step 515).

Although the invention has been described with reference to a particular arrangement of parts, features and the like, these are not intended to exhaust all possible arrangements or features, and indeed many modifications and variations will be ascertainable to those of skill in the art.

What is claimed is:

1. A system for facilitating post-trade processing of a securities trade, comprising:
an integration server;
a plurality of post-trade systems accessible by said integration server;
software executing on said integration server for receiving trade allocation data from at least one investment manager via a user interface;
software executing on said integration server for receiving trade execution data from at least one broker;
software executing on said integration server for determining, at least in part based on content of the data, at least one of the post-trade systems corresponding to at least one of the trade execution data and the trade allocation data;
software executing on said integration server for sending at least a portion of the trade execution data and the trade allocation data to the at least one determined post-trade system; and
software executing on said integration server for receiving confirmation data from the at least one determined post-trade system.

2. The system according to claim 1, further comprising:
translation software executing on said integration server for translating at least one of the trade execution data and the trade allocation data to a format corresponding to the at least one post-trade system.

3. The system according to claim 1, wherein said plurality of post-trade systems include post-trade systems for processing securities trades for each of at least three asset classes.

4. The system according to claim 3, wherein the plurality of post-trade systems include at least one securities trade matching system and at least one post-trade system for providing trade settlement instructions.

5. The system according to claim 3, wherein each of the trade execution data and the trade allocation data includes an asset class identifier, wherein said at least one post-trade system is determined based on the asset class identifier.

6. The system according to claim 1, further comprising:
a table of data identifiers accessible by said integration server for identifying one or more of the plurality of post-trade systems,
wherein said software for determining the at least one post-trade system compares at least a portion of each of the trade allocation data and the trade execution data to the data identifiers.

7. The system according to claim 1, wherein the confirmation is indicative of a matched trade.

8. The system according to claim 1, wherein the confirmation data is displayed on the user interface.

9. The system according to claim 1, further comprising:
software executing on said integration server for determining status data for a plurality of securities trades; and
software executing on said integration server for providing the status data to the at least one investment manager via the user interface.

10. The system according to claim 1, wherein the at least one broker is one of an equities broker, a fixed-income investments broker, a money markets broker and a derivatives broker.

11. The system according to claim 1, further comprising:
at least one enrichment database accessible by said integration server; and
software executing on said integration server for enriching at least one of the trade execution data and trade allocation data with enrichment data from the at least one enrichment database.

12. The system according to claim 1, further comprising:
at least one communications platform accessible by said integration server.

13. The system according to claim 1, wherein the trade execution data is indicative of an executed securities trade and the trade allocation data is indicative of an ordered securities trade.

14. A system for facilitating post-trade processing of a securities trade, comprising:
an integration server;
a plurality of trade matching applications accessible by said integration server for matching trades in at least three asset classes;
software executing on said integration server for receiving trade allocation data from at least one first trading party via a user interface;
software executing on said integration server for receiving trade execution data from at least one second trading party;
software executing on said integration server for determining, based at least in part on content of the data, at least one of the plurality of trade matching applications corresponding to each of the trade execution data and the trade allocation data;
an application accessible by said integration server for receiving trade settlement instructions corresponding to at least one of the trade allocation data and the trade execution data; and
software executing on said integration server for providing status data from the plurality of trade matching applications to the at least one first trading party via the user interface.

15. The system according to claim 14, further comprising:
software executing on said integration server for determining one of the at least three asset classes corresponding to each of the trade execution data and the trade allocation data.

16. The system according to claim 14, wherein the asset classes include equities, fixed income, derivatives, and cash.

17. A method for facilitating post-trade processing, comprising the steps of:
receiving a plurality of trade allocation data from at least one first trading party;
receiving a plurality of trade execution data from at least one second trading party;
determining an asset class for each of the trade execution data and the trade allocation data;
determining a post-trade matching system for each of the trade execution data and the trade allocation data;
comparing trade execution data pertaining to a particular asset class with trade allocation data pertaining to the particular asset class to determine a match; and
generating confirmation data for transmission to the at least first trading party and the at least one second trading party if a match is found.

18. The method according to claim 17, further comprising the step of:
translating at least one of the trade execution data and the trade allocation data to a data format corresponding to the determined post-trade matching system.

19. The method according to claim 17, wherein the asset class is one of equities, fixed income, derivatives, and cash.

20. The method according to claim 17, further comprising the step of:
generating exception data for transmission to the at least one first trading party and the at least one second trading party if no match is found.
